(19) United States
(12) Patent Application Publication
(10) Pub. No.: US 2003/0156817 A1
(43) Pub. Date: Aug. 21, 2003

(54) High performance variable optical attenuation collimator with an embedded micro lens

(75) Inventor: Yi He, Saratoga, CA (US)

Correspondence Address: C. P. Chang, c/o Pacific Law Group LLP, Suite 290, 2 North Second Street, San Jose, CA, 95113, US

(73) Assignee: Global Opticom, Inc., Sunnyvale, CA

(21) Appl. No.: 10/236,238

(22) Filed: Sep. 5, 2002

Related U.S. Application Data
(63) Continuation-in-part of application No. 10/078,219, filed on Feb. 15, 2002.

(51) Int. Cl. G02B 6/00; G02B 6/32

(52) U.S. Cl. 385/140; 385/33

(57) ABSTRACT

A Variable Optical Attenuation Collimator (VOAC) with a controllable mechanism and of improved optical performance is disclosed to achieve a low IL, a low PDL, a high RL, a low PMD, a low WDL and a high maximum level of input light power by adding a transparent micro lens to the Attenuation Control Element (ACE) that is disposed between a lens element and fiber pigtails of a traditional fiber optical collimator. The micro lens functions to redirect the blocked light power substantially out of the main light path without any significant absorption of the blocked light power. The micro lens can be made of any kind of transparent optical materials such as a cured drop of an epoxy, glass or transparent polymer. When the micro lens diameter is properly selected the improved optical performance is achieved for the VOAC.

### CROSS REFERENCE TO RELATED APPLICATION

This application is a Continuation-In-Part (CIP) of an earlier filed U.S. patent application entitled “A VARIABLE OPTICAL ATTENUATION COLLIMATOR WITH CONTROLLABLE LIGHT BLOCKING MECHANISMS” by the same inventor and filed on Feb. 15, 2002 with Ser. No. 10/078,219, hereafter referred to as the “He U.S. application”

### FIELD OF THE INVENTION

The present invention relates generally to the field of fiber optical components used in fiber optical communications. More particularly, the present invention discloses an improved Variable Optical Attenuation Collimator (VOAC) having the performance characteristics of low Insertion Loss (IL), low Polarization Mode Dispersion (PMD), low Polarization Dependent Loss (PDL), low Wavelength Dependent Loss (WDL), high Return Loss (RL) and high propagation light power.

### BACKGROUND OF THE INVENTION

The industry of fiber optical communications has already proven to be indispensable for the achievement of low noise, long distance telecommunication with a heretofore-unrealizable high bandwidth. Within a fiber optical network a Variable Optical Attenuator (VOA) is an important basic component providing the function of controlling the level of propagated light power, such as a single-channel VOA or a VOA array. The VOA can be combined with other fiber optical components to form modules of a higher level of functionality, such as a Dense Wavelength Division Multiplexer (DWDM), an Optical Add/Drop Multiplexer (OADM) and a Programmable Optical Add/Drop Multiplexer (POADM). For example, in a DWDM, the uniformity of optical power level amongst the different wavelengths is changed after it passes through Erbium-Doped Fiber optical Amplifiers (EDFAs) and associated fibers. In this case, a VOA is one of the simplest solutions to rebalance the optical power level amongst the various wavelengths.

Recently, the need and associated art of making the VOA has increased a lot because of the demand of real-time, dynamic light power management within a fiber optical system, especially because of the market attention has turned from long-haul systems toward metro-systems and even local networks and direct fiber delivery to individual homes.

In most of the applications, VOA is being deployed in-line, thus the optical performance of the VOA becomes more and more important as the number of nodes continues to increase in a dynamic network. The key requirement of the VOA component is that it only controls the level of propagation light power without incurring significant extra IL, WDL, PMD and PDL. Additionally, the VOA needs to provide a high RL within a wide range of propagation light power and temperature.

As detailed in the He U.S. application, good progress has been made in the VOAC by embedding the VOA function of various designs in a regular fiber optical collimator. That is, parts providing the VOA functionality are packaged in an otherwise regular fiber optical collimator since the fiber optical collimator is the only ideal optical platform in the fiber-optic industry. However, to retain the original superior optical performance of the collimator, the embedded VOA parts of the VOAC must be very carefully designed and this is the subject of the present invention.

### SUMMARY

The present invention is directed to a VOAC with the performance characteristics of low IL, low PMD, low PDL, low WDL, high RL and high power controllability by using controllable light blocking mechanisms at an internal focal point of the VOAC.

### BRIEF DESCRIPTION OF DRAWINGS

The current invention will be better understood and the nature of the objectives set forth above will become apparent when consideration is given to the following detailed description of the preferred embodiment treatment. For clarity of explanation, the detailed description further makes reference to the attached drawings herein:

FIG. 1A illustrates a structure of a traditional multi-fiber optical collimator;

FIG. 1B illustrates a structure of a multi-fiber optical collimator of the He U.S. application with the inclusion of an Attenuation Control Element (ACE);

FIG. 2A, FIG. 2B and FIG. 2C illustrate an embodiment of the design and operation of the ACE within the VOAC as described in the He U.S. application;

FIG. 2D and FIG. 2E illustrate the degradation of various performance parameters from the VOAC of the He U.S. application;

FIG. 3A and FIG. 3B illustrate an embodiment of the present invention whereby improved performance parameters are achieved for the VOAC; and

FIG. 4A and FIG. 4B illustrate an optical effect exploited by the present invention for the simultaneous achievement of low PMD, low PDL, low WDL, high RL and high power controllability for the VOAC.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention.

Reference herein to “one embodiment” or an “embodiment” means that a feature, structure, or characteristics described in connection with the embodiment can be included in any embodiment adopting controllable mechanisms.

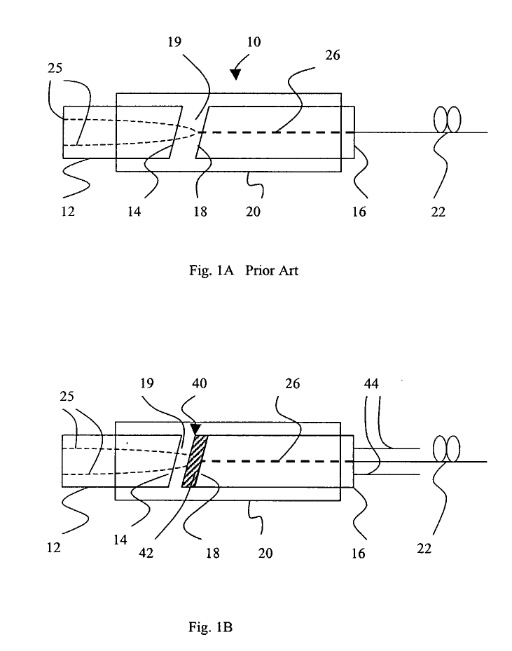

FIG. 1A illustrates a structure of a traditional multi-fiber optical collimator 10. The traditional multi-fiber optical collimator 10 comprises a lens 12 separated from a pigtail 16 with an air gap 19. The lens 12 and the pigtail 16 are affixed to a common housing tube 20. The right end of the pigtail 16 is attached to a fiber assembly 22 containing one or more optical fibers. Typically, as is well known in the art, the lens 12 is made of an appropriate GRaded INdex of refraction (GRIN) lens whereby a laser light entering the left end of the lens 12 is automatically focused onto the proper entry point of the pigtail 16 for further propagation along the pigtail 16 with minimum light loss. This is illustrated with an intra-lens light path 25 and an intra-pigtail light path 26. Finally, the light enters the fiber assembly 22 from the right end of the pigtail 16 for further propagation. Notice that, as is also well known in the art, both the lens 12 and the pigtail 16 have tilted, with respect to the optical axis, yet parallel to each other surfaces for the maximization of return loss. These are tilted lens surface 14 and tilted pigtail surface 18 respectively. Due to optical reciprocity, another situation wherein the light enters the traditional multi-fiber optical collimator 10 from its right end of fiber assembly 22 works just as well.

FIG. 1B illustrates a structure of a multi-fiber optical collimator of the He U.S. application with the addition, within the existing air gap 19, of an ACE 40 comprising a ACE body 42 and ACE control electrodes 44 attached to the ACE body 42 although the attachment, being blocked from view by the pigtail 16, is not directly visible. Otherwise, the rest of the structure of the present invention is the same as that of the traditional multi-fiber optical collimator 10. Functionally, as will be presently illustrated, the ACE body 42 causes a predetermined amount of light attenuation through it with the amount of light attenuation further controlled with control signals applied through the ACE control electrodes 44 to realize the function of a VOAC. As the ACE 40 is added in the existing air gap 19 of the traditional multi-fiber optical collimator 10, there is no incremental size increase of the collimator.

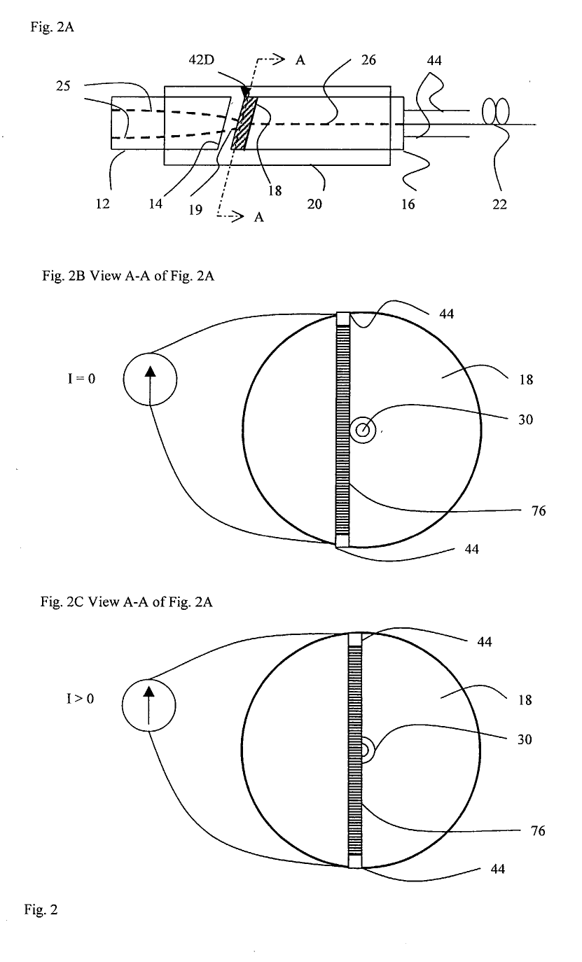

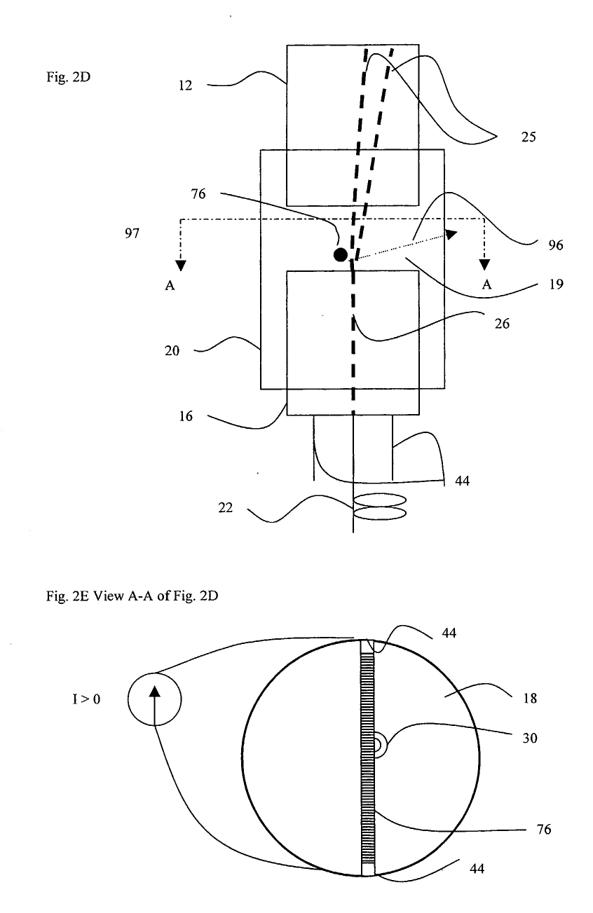

FIG. 2A, FIG. 2B and FIG. 2C illustrate a structure and operation of a multi-fiber VOAC of the He U.S. application. The traditional parts of the structure are the same as those described in FIG. 1A.

An ACE body 42D is mounted onto the tilted pigtail surface 18 within the existing air gap 19. The details of the ACE body 42D is illustrated in a VIEW A-A of FIG. 2B. The ACE body embodies a micro mechanism that can be controlled by a driving current, a driving voltage, an applied magnetic force or any other driving means. These were described in more details from paragraph (17) through paragraph (25) of the He U.S. application, incorporated herein by reference. For simplicity of illustration while setting forth the inventive concept without loosing the scope of the present invention, the following description is only illustrated wherein the ACE body 42D is controlled by a driving current. The ACE body 42D comprises a light blocker 76, and, for example, with a pair of attached ACE control electrodes 44 for the supply of an externally provided control current I. Additionally, the light blocker 76 is elastically and slidably mounted onto the tilted pigtail surface 18 with the associated direction of movement being parallel to the tilted pigtail surface 18 while perpendicular to the direction of the light blocker 76. For example, a means of mounting the light blocker 76 can be through a pair of miniature springs although they are not shown here for simplicity of view. The light blocker 76 is located at one side of and remains clear of the pigtail fiber end surface 30 through which a main light beam propagates. Furthermore, an induced magnetic force can be developed, due to the presence of a separately provided permanent magnetic field 78, to move the light blocker 76 in front of the pigtail fiber end surface 30 to obstruct a corresponding amount of propagating light power there through. Hence, in the absence of an externally supplied control signal there is essentially no optical power attenuation through the ACE body 42D. This is illustrated in FIG. 2B with I=0. However, with the application of an externally supplied control signal I>0, the light blocker 76 gets moved, under a magnetic force generated from the permanent magnetic field 78, into a path of the main light beam at the pigtail fiber end surface 30 so as to obstruct a corresponding amount of propagating light power causing an equivalent amount of optical power attenuation through the ACE body 42D as is illustrated in FIG. 2C.

FIG. 2D and FIG. 2E illustrate the degradation of various performance parameters of the VOAC of the He U.S. application where the light power of an intra-pigtail light path 26, on its way toward the lens 12, gets partially blocked by the light blocker 76 before it turns into the intra-lens light path 25. Concurrently, as shown in FIG. 2D, there is also an unavoidable amount of attenuated stray light 96 either reflected from or scattered off the surface of the light blocker 76 and some portion of the attenuated stray light 96 can end up unintentionally reentering the lens 12 as propagated stray power or even being back scattered toward the pigtail 16 as reflected stray power. Furthermore, in typical practice the surface of the light blocker 76 is that of a rough metal making the corresponding reflectance significantly dependent upon the polarization of an incident light field. Hence, the propagated stray power and the reflected stray power would respectively cause performance degradations of the VOAC in the form of an increased PDL and a decreased RL and are difficult to control. It is remarked that, while the direction of light is illustrated as propagating from the pigtail 16 to the lens 12, the physical mechanism causing the just illustrated performance degradations of the VOAC remains the same where the light instead propagates from the lens 12 to the pigtail 16.

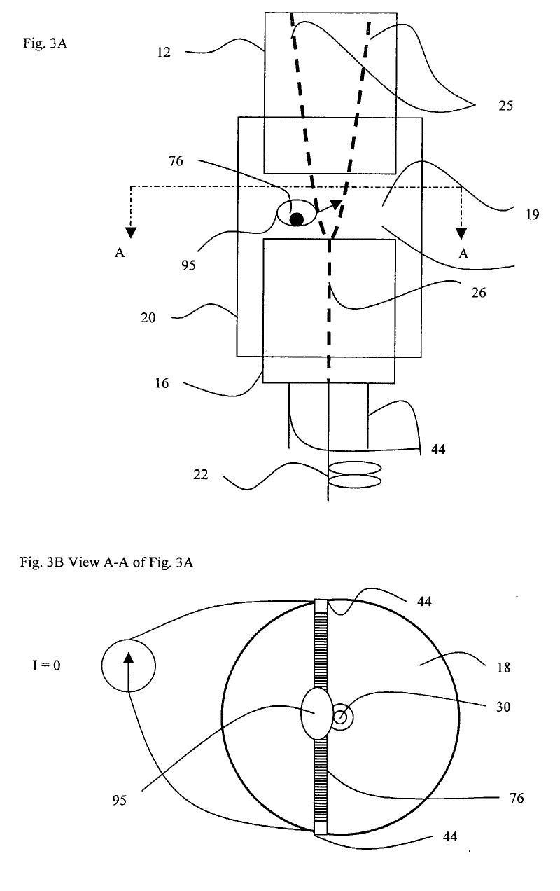

FIG. 3A and FIG. 3B illustrate an embodiment of the present invention whereby improved performance parameters are achieved for the VOAC. The traditional parts of the structure remain the same as those described in FIG. 1A. A micro lens 95 of typical diameter ranging from 30 μm to 60 μm and made of an optically transparent material is added onto the light blocker 76 near the propagating light beam. For example, the micro lens 95 can be made by curing a tiny drop of transparent epoxy applied at a corresponding location of the light blocker 76. By way of illustration, not by way of limitation, the epoxy may be obtained from a variety of commercial sources. For example, a preferred epoxy suitable as a micro lends according to the present invention is obtainable under the product name, Epo Tek 353 ND, manufactured by Epoxy Technology, Inc. located at 14, Fortune Drive, Billerica, Mass. Additionally, a polyurethane oligomer mixture, namely, ELC4481, manufactured by Electro-Lite Corporation located at 43 Miry Brook Road, Danbury, Conn., also suits this purpose. While other transparent materials such as glass, quartz, transparent polymer, etc. can also be used to form the micro lens 95, these transparent epoxies are preferred considering their inherently easy manufacturing steps. Furthermore, the lens profile can be convex or concave for full functionality although a convex profile is a much easier form for manufacturing. Like before, when there is no driving signal applied (I=0), the light blocker 76 together with the micro lens 95 do not touch the propagating light beam with no light being scattered or diffracted, thus the IL remains the same as that of a regular collimator.

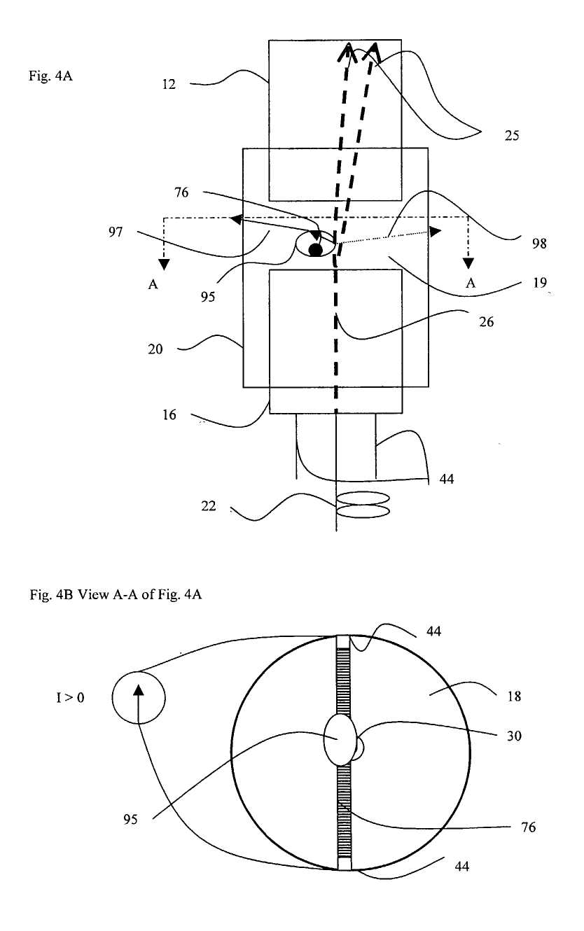

FIG. 4A and FIG. 4B illustrate an optical effect exploited by the present invention for the simultaneous achievement of low PMD, low PDL, low WDL, high RL and high power controllability for the VOAC. As the near-focus diameter of the light beam is about 8 μm, the typical diameter chosen for the micro lens 95 ranges from 30 μm to 60 μm for a full coverage of the cross section of the light beam. Under the application of a corresponding control signal (I>0), the light blocker 76 together with the micro lens 95 has moved to an indicated new position where the micro lens 95 overlaps part of the propagating light beam. While the non-overlapping part of the propagating light beam travels as usual along the intra-lens light path 25, the overlapped part of the propagating light beam gets split under the power of the micro lens 95 in two directions, a reflected stray light 97 along a reflected direction and a refracted stray light 98 along a refracted direction. Furthermore, as illustrated, the specific diameter of the micro lens 95 is chosen so as to cause both the direction of the reflected stray light 97 and the direction of the refracted stray light 98 to become substantially perpendicular to the original propagation direction of the propagating light beam. Consequently, as similarly illustrated, the majority of either the reflected stray light 97 or the refracted stray light 98 does not end up unintentionally reentering the lens 12 as propagated stray power or reentering the pigtail 16 as reflected stray power. In this way, the performance parameters of PDL and RL of the VOAC are significantly improved. It is remarked that a regular collimator achieves high RL by forming a pair of tilted surfaces along the light path, for instance, the tilted lens surface 14 and the tilted pigtail surface 18 of FIG. 1A. Under the same principle, therefore, if the local light-intersecting surface of the micro lens 95 is made, with the choice of a proper lens diameter, non-perpendicular to the light path, a desired high RL is likewise realized.

It is well known in the art that the PMD of a regular collimator is very low which is highly desirable. The implication indicates that if the majority of the reflected stray light 97 and the refracted stray light 98 do not propagate along the main light path, the superiority of a low PMD will be preserved in the VOAC. Therefore a low PMD for the VOAC is simultaneously achieved by a proper choice of the micro lens diameter as discussed above to obtain a desirable PDL and RL. Similarly, a low WDL is simultaneously achieved by using the same lens diameter to separate the reflected stray light power and the refracted stray light power from the main propagating light power as the latter is also insensitive to both polarization and wavelength of the light in light of the fact that the micro lens 95 is made of a transparent material.

The micro lens 95, being transparent to the incident light power, redirects the blocked light out of the VOAC without significant absorption. This is also illustrated in FIG. 4B. As there is very little blocked light power transformed into heat via absorption internally to the VOAC structure, the VOAC can continue to function well up to a high level of input light power.

It is remarked that, while the various advantages of the micro lens 95 are illustrated with a direction of light propagating from the pigtail 16 to the lens 12, the underlying physical mechanisms resulting in the various advantages of the micro lens 95 of the VOAC remains the same where the light instead propagates from the lens 12 to the pigtail 16.

As described above, by adding a transparent micro lens of a selected diameter to the light blocker of a VOAC thus properly redirecting the correspondingly blocked light power, the resulting performance parameters of PDL, RL, PMD, WDL and maximum level of input light power of the VOAC can be significantly improved simultaneously while preserving an initially low IL. To those skilled in the art, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed are the following:

1. A multi-fiber, Variable Optical Attenuation Collimator (VOAC) for providing a variable degree of optical power attenuation to a light beam propagating there through, the VOAC comprising:
a lens element and a fiber pigtail having one or more optical fibers attached to a right end of said fiber pigtail, separated by an air gap wherein said lens element and said fiber pigtail are both affixed to a common housing tube in such a manner that said light beam entering at a left end of said lens element is automatically focused onto a proper entry point of said fiber pigtail for further propagation along said fiber pigtail to define a main light path;
an Attenuation Control Element (ACE) comprising a light blocker being movably mounted onto a surface of said fiber pigtail within said air gap in close proximity to yet clear of said main light path, said light blocker having a micro lens attached thereto; and
a driving means, including a driving signal, being connected to said ACE to provide a controllable movement of said light blocker such that said micro lens and said light blocker will obstruct all, a portion or none of said light beam propagating through said main light path from said lens element to said fiber pigtail to achieve said variable degree of optical power attenuation.

2. The VOAC of claim 1 wherein said micro lens is made of a material that is transparent to said light beam.

3. The VOAC of claim 2 wherein said transparent material is an epoxy namely, Epo Tek 353 ND, manufactured by Epoxy Technology, Inc.

4. The VOAC of claim 2 wherein said transparent material is an UV epoxy namely, ELC 448, manufactured by Electro-Lite Corporation.

5. The VOAC of claim 2 wherein said transparent material is further selected from a group consisting of glass, quartz and a transparent polymer.

6. The VOAC of claim 1 wherein said micro lens is chosen with a diameter in a range of 30 μm to 60 μm so as to properly reflect and refract the correspondingly blocked light power in directions substantially perpendicular to the direction of said main light path.

7. The VOAC of claim 6 wherein said micro lens is chosen with a diameter in said range so as to minimize the Polarization Dependent Loss (PDL) of said VOAC.

8. The VOAC of claim 6 wherein said micro lens is chosen with a diameter in said range so as to maximize the Return Loss (RL) of said VOAC.

9. The VOAC of claim 6 wherein said micro lens is chosen with a diameter in said range so as to minimize the Polarization Mode Dispersion (PMD) of said VOAC.

10. The VOAC of claim 6 wherein said micro lens is chosen with a diameter in said range so as to minimize the Wavelength Dependent Loss (WDL) of said VOAC.

11. The VOAC of claim 6 wherein said micro lens is chosen with a diameter in said range so as to maximize the maximum level of an input light power to said VOAC.

12. The VOAC of claim 6 wherein said micro lens is chosen with a diameter in said range so as to simultaneously achieve desirable performance objectives such as minimizing the PDL, maximizing the RL, minimizing the PMD, minimizing the WDL, and maximizing the maximum level of an input light power to said VOAC.

13. The VOAC of claim 12 wherein said desirable performance objectives further includes a degenerate case, having a corresponding level of said driving signal, of essentially no optical power attenuation to achieve a corresponding low Insertion Loss (IL).
